(19) United States
(12) Patent Application Publication
(10) Pub. No.: US 2007/0201341 A1
(43) Pub. Date: Aug. 30, 2007

(54) Optical Device For Recording And Reproducing

(75) Inventors: Joris Jan Vrehen, Eindhoven (NL); Petrus Theodorus Jutte, Eindhoven (NL)

Correspondence Address: DAVID E. HUANG, ESQ.;BAINWOOD HUANG & ASSOCIATES LLC, 2 CONNECTOR ROAD, SUITE 2A, WESTBOROUGH, MA, 01581, US

(73) Assignee: Arima Devices Corporation, Road Town (VG)

(21) Appl. No.: 10/588,635

(22) PCT Filed: Jan. 31, 2005
(86) PCT No.: PCT/IB05/00235

§ 371 Date: Apr. 16, 2007

(30) Foreign Application Priority Data
Feb. 5, 2004 (EP) 04300065.2

(51) Int. Cl. G11B 7/00

(52) U.S. Cl. 369/112.05; 369/100

(57) ABSTRACT

The invention relates to an optical device comprising a radiation source (101) for producing a radiation beam and means (103, 106) for focusing the radiation beam on an information carrier (100) along an optical path. The radiation beam has a central axis, an outer envelope and an intensity distribution. The optical device further comprises, in the optical path, an optical component (104) designed for increasing the RIM intensity and thus the radio between the intensity near the envelope and the intensity near the central axis in that at least the radiation beam near the central axis is diffracted.

### FIELD OF THE INVENTION

The present invention relates to an optical device for writing to and/or reading from an information carrier.

The present invention also relates to a method for writing to and reading from an information carrier.

The present invention also relates to an optical component.

The present invention is particularly relevant for an optical disc apparatus for recording to and reading from an optical disc, e.g. a CD, a DVD or a Blu-Ray Disc (BD) recorder and player.

### BACKGROUND OF THE INVENTION

In order to record data on and read data from an information carrier such as an optical disc, a radiation beam is used in an optical device. The information carrier comprises a recording layer, whose properties can be modified locally in that a high-intensity radiation beam is applied. The local changes induced in the recording layer correspond to written data and are subsequently used for reproducing the information by means of a lower-intensity radiation beam. For example, a phase change material is used as recording layer. During writing, the recording layer is altered by the high-intensity radiation beam, but the resulting information layer is not altered during reading, because a low-intensity radiation beam is used for reading.

The radiation beam is produced by a radiation source and is focused on the information layer along an optical path by means of a collimator lens and an objective lens. Along the optical path, the radiation beam is predominantly a parallel beam having a central axis and an outer envelope. The radiation beam has an intensity distribution, which depends on the radiation source and the optical device. In known optical devices, the intensity of the beam near the central axis is greater than the intensity near the outer envelope. The ratio between the intensity near the outer envelope and the intensity near the central axis of the radiation beam is called the rim intensity.

In order to record data on and read data from an information layer of the information carrier, a certain amount of rim intensity is required. Actually, if the rim intensity is too low, the quality of the spot formed by the beam on the information layer is bad, and the writing and reading processes are affected.

In order to increase the rim intensity, the numerical aperture taken from the radiation source as defined by the focal length of the collimator lens and the pupil of the objective lens is reduced in the known optical devices. This numerical aperture is called the collimator lens numerical aperture. When the collimator lens numerical aperture is increased, the rim intensity rises. As a consequence, the far field of the radiation beam is more cut

However, cutting a bigger part of the far field of the radiation beam implies that the optical throughput from the radiation source to the information carrier is reduced. The optical throughput is the ratio between the power of the radiation beam on the information carrier and the power of the radiation beam produced by the radiation source. Now, as certain intensities of the radiation beams are required for recording on and reading from the information carrier, this implies that the power of the radiation source has to be increased in order to obtain the desired beam intensities.

This is a drawback, because it decreases the lifetime of the radiation source, which is, for example, a laser diode, or it limits the maximum writing speed. Moreover, this increases the electrical power consumption, which is a drawback, especially in portable devices.

### SUMMARY OF THE INVENTION

It is an object of the invention to provide an optical device comprising means for increasing the rim intensity, in which optical device the optical throughput is relatively high.

To this end, the invention proposes an optical device comprising a radiation source for producing a radiation beam and means for focusing the radiation beam on an information carrier along an optical path, said radiation beam having a central axis and an outer envelope, said radiation beam having an intensity distribution, the optical device further comprising, in the optical path, an optical component designed for increasing the ratio between the intensity near the envelope and the intensity near the central axis in that at least the radiation beam near the central axis is diffracted.

According to the invention, the intensity near the central axis of the radiation beam is reduced. Actually, when the radiation beam near the central axis is diffracted, only part of the radiation beam near the central axis is transmitted towards the information carrier. The intensity near the envelope of the radiation beam may also be reduced, but the optical component is designed such that the ratio between the intensity near the envelope and the intensity near the central axis is increased. As a consequence, the rim intensity is increased. Furthermore, the far field of the radiation beam is not cut, which means that the optical throughput remains relatively high, at least higher than in the known optical devices where the numerical aperture of the collimator is reduced.

In an advantageous embodiment, the radiation beam comprises at least a first and a second direction perpendicular to the central axis, the radiation beam having a first intensity distribution with a first mean intensity in the first direction and a second intensity distribution with a second mean intensity in the second direction, said second mean intensity being greater than the first mean intensity, wherein the optical component is designed for diffracting the radiation beam in the second direction more strongly than in the first direction.

The radiation sources usually used in optical devices have a beam divergence aspect ratio greater than one. This leads to an elliptically shaped spot, which affects the writing and reading of data. In the known optical devices, this is compensated by a beam shaper which transfers the elliptical far field of the laser into a more round far field. However, such a beam shaper requires careful aligning with the collimator and the objective lens, which complicates the assembling process of the optical device. According to this advantageous embodiment, no beam shaper is required, as the optical component is designed for compensating the beam divergence aspect ratio of the radiation source. As a consequence, the optical device is less bulky and the assembling process of the optical device is easier.

Advantageously, the optical component has a phase structure with a phase depth which decreases from the central axis to the outer envelope of the radiation beam. Such a phase structure is well adapted for increasing the rim intensity of radiation beams having an intensity which decreases from the central axis to the outer envelope. The distribution of the phase depths of the phase structure can be arranged in order to match the intensity distribution of the radiation beam, in which case the rim intensity is close to one. Such a phase structure can easily be moulded or replicated in an optical component already present in the optical path.

Preferably, the optical component has a phase structure with a duty cycle which decreases from the central axis to the outer envelope of the radiation beam. Such a phase structure is well adapted for increasing the rim intensity of radiation beams having an intensity which decreases from the central axis to the outer envelope. Moreover, as the phase depth of said phase structure is constant, the phase structure does not introduce wavefront aberrations in the radiation beam.

Advantageously, the optical component has a phase structure with a diffraction profile which can be changed in accordance with a mode of operation of the optical device. This is particularly advantageous, because the required intensity of the radiation beam and the required rim intensity are not the same during writing and reading. Actually, a relatively low intensity of the radiation beam and a relatively high rim intensity are required during reading. During writing, an higher intensity of the radiation beam is required, but a lower rim intensity may be used. As the diffraction profile of the phase structure can be changed when the optical device goes from a writing mode to a reading mode, it is possible to take into account the required rim intensities and intensities of the radiation beam.

Preferably, the optical component has a periodic phase structure. In this case, the phase structure creates three orders of diffraction. As a consequence, one main spot and two satellite spots are created. These three spots can be used for the so-called “3 spots push-pull tracking” method. Hence, the light that is removed from the radiation beam to increase the rim intensity is used to create the two satellite spots used in the 3 spots push-pull tracking method. As a consequence, no light is lost in such an optical scanning device, which means that the optical throughput is relatively high.

The invention also relates to a method of writing to and reading from an information carrier with an optical device comprising a radiation source for producing a radiation beam and means for focusing the radiation beam on the information carrier along an optical path, said radiation beam having a central axis and an outer envelope, said radiation beam having an intensity distribution, said method comprising the steps of providing in the optical path, during writing, an optical component designed for increasing the ratio between the intensity near the envelope and the intensity near the central axis in that a first percentage of the beam near the central axis is diffracted, and changing the diffraction profile of said optical component during reading, such that said optical component diffracts a second percentage of the intensity of the beam near the central axis, the second percentage being larger than the first percentage.

The invention also relates to an optical component comprising a phase structure having a variable phase depth and to an optical component comprising a phase structure having a variable duty cycle. Preferably, the phase structure of said components is periodic.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical device in accordance with the invention;

FIG. 2 is a cross section of an optical component of FIG. 1;

FIGS. 3a, 3b, 3c and 3d are top views of the optical component of FIG. 1;

FIG. 4a is a cross section of an optical component in an advantageous embodiment of the invention and FIG. 4b is a cross section of an optical component in a preferred embodiment of the invention;

FIG. 5 is a cross section of an optical component having a switchable diffraction profile.

### DETAILED DESCRIPTION OF THE INVENTION

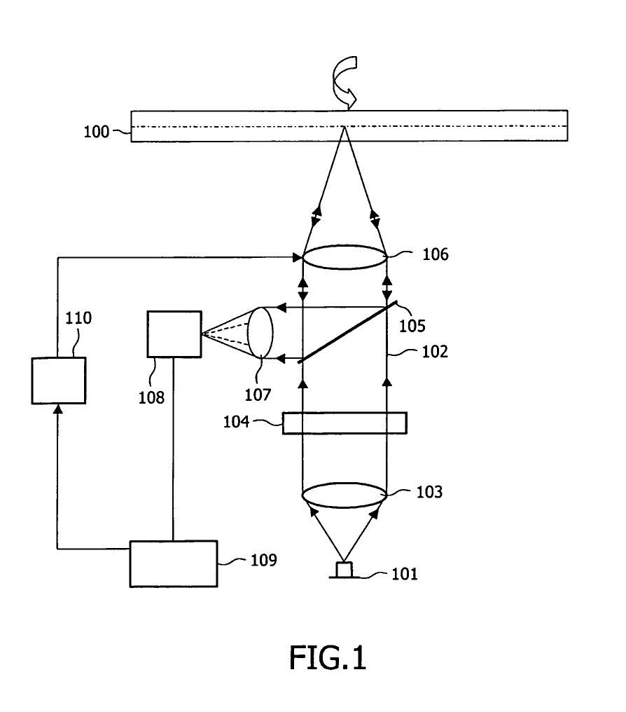

An optical device according to the invention is depicted in FIG. 1. Such an optical device comprises a radiation source 101 for producing a radiation beam 102, a collimator lens 103, an optical component 104, a beam splitter 105, an objective lens 106, a servo lens 107, detecting means 108, measuring means 109, and a controller 110. This optical device is intended for scanning an information carrier 100.

During a scanning operation, which may be a writing operation or a reading operation, the information carrier 100 is scanned by the radiation beam 102 produced by the radiation source 101. The collimator lens 103 and the objective lens 106 focus the radiation beam 102 on an information layer of the information carrier 100. The collimator lens 103 and the objective lens 106 are focusing means. During a scanning operation, a focus error signal may be detected, corresponding to an error of positioning of the radiation beam 102 on the information layer. This focus error signal may be used for correcting the axial position of the objective lens 106, so as to compensate for a focus error of the radiation beam 102. A signal is sent to the controller 110, which drives an actuator in order to move the objective lens 106 axially.

The focus error signal and the data written on the information layer are detected by the detecting means 108. The radiation beam 102, reflected by the information carrier 100, is transformed into a parallel beam by the objective lens 106, and then reaches the servo lens 107, by means of the beam splitter 105. This reflected beam then reaches the detecting means 108.

The optical component 104 is designed for transmitting only a certain percentage of the intensity of the radiation beam 102 towards the objective lens 106. To this end, the optical component 104 is designed for diffracting at least a portion of the radiation beam 102. According to the invention, the optical component 104 diffracts a relatively low percentage of the intensity of the portion of the radiation beam 102 located near the outer envelope of the radiation beam 102 and a relatively high percentage of the intensity of the portion of the radiation beam 102 located near the central axis of the radiation beam 102. The optical scanning device is designed in such a way that the diffracted light does not contribute to the spot-formation on the information carrier 100 and does not reach the detecting means 108 after reflection.

As a consequence, the rim intensity of the radiation beam 102 before the objective lens 106 is increased. Such an increase is obtained without cutting the far field of the radiation beam 102. Even if the intensity of the radiation beam 102 before the objective lens 106 is reduced, it is less strongly reduced than in the prior art, where the far field of the radiation beam is cut much more, especially for high rim intensities. As a consequence, given a certain rim intensity, higher optical throughputs are obtained in accordance with the invention. Hence, the radiation source 101 can be operated at a lower electrical power, which decreases the power consumption of the optical device and increases the lifetime of the radiation source 101 or increases the recording speed.

The optical component 104 is placed in the optical path of the radiation beam 102, which corresponds to the way traveled by the radiation beam 102 from the radiation source 101 to the information carrier 100. In this example, the optical component 104 is placed between the collimator lens 103 and the beam splitter 105, but it may be placed elsewhere on the optical path. In particular, the optical component 104 designed for increasing the ratio between the intensity near the envelope and the intensity near the central axis in that at least the radiation beam near the central axis is diffracted, may be an optical component already present in the optical scanning device, such as the collimator lens 103. In this case, a phase structure is provided on said collimator lens 103, which phase structure is designed for diffracting at least the radiation beam near the central axis. Examples of such a phase structure are given in the next Figs.

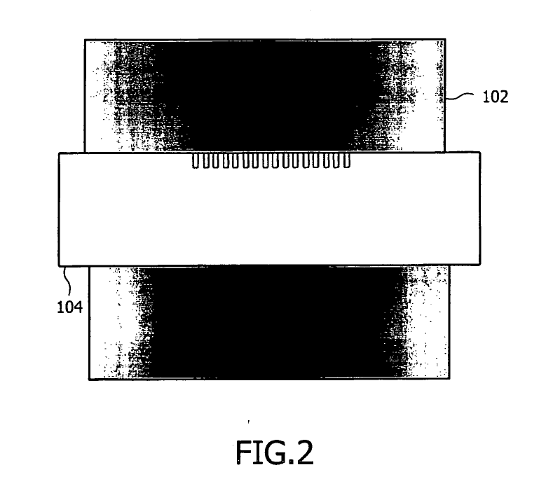

FIG. 2 shows an example of the optical component 104. In this example, the optical component 104 comprises a phase structure located around the central axis of the radiation beam 102. The portion of the radiation beam 102 that passes through said phase structure is diffracted, whereas the portion of the radiation beam that does not pass through said phase structure is completely transmitted by the optical component 104. FIG. 2 shows the intensity distribution of the radiation beam 102 before and beyond the optical component 104. Thanks to the phase structure, the intensity near the central axis of the radiation beam 102 is reduced, whereas the intensity near the outer envelope remains unchanged. As a consequence, the rim intensity is increased.

In the example of FIG. 2, the phase structure is periodic. As a consequence, the portion of the radiation beam 102 located near the central axis of said radiation beam 102 is diffracted in three orders of diffraction. The 0^{th} order is represented in FIG. 2. The two other orders of diffraction give rise to two spots that are consequently focused on the information carrier 100. These two additional spots that are created by means of the optical component 104 can be used for tracking, using the well-known 3 spots push-pull tracking method. As a consequence, the light that is removed from the radiation beam 102 in order to increase the rim intensity is used for tracking, which means that no light is lost in the optical scanning device, hence increasing the optical throughput.

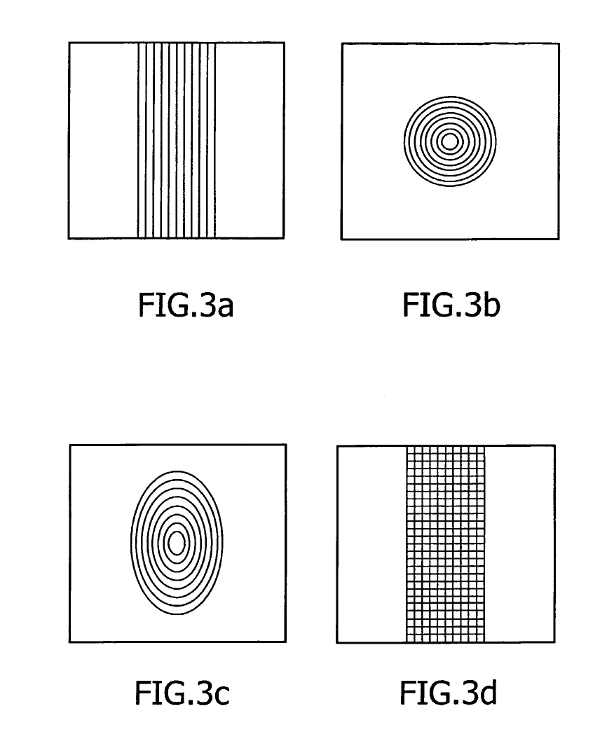

FIGS. 3a to 3d show possible top views of the optical component 104, which cross section is represented in FIG. 2. In the example of FIG. 3a, the optical component 104 comprises a conventional grating that diffracts light in only one dimension. Such an optical component is well adapted for radiation beams having an intensity distribution that varies according to one preferred direction, which is perpendicular to the tracks represented in FIG. 3a.

In the example of FIG. 3b, the optical component 104 comprises a circular grating that diffracts light in two dimensions. Such an optical component is well adapted for radiation beams having a circularly distributed intensity.

In the example of FIG. 3c, the optical component 104 comprises an elliptical grating that diffracts light in two dimensions. Such an optical component is well adapted for radiation beams having an elliptically distributed intensity. Such a radiation beam comprises a first and a second direction perpendicular to the central axis and has a first intensity distribution with a first mean intensity in the first direction and a second intensity distribution with a second mean intensity in the second direction, said second mean intensity being greater than the first mean intensity. Such an optical component 104 with an elliptical grating is designed for diffracting the radiation beam in the second direction more strongly than in the first direction.

In the example of FIG. 3d, the optical component 104 comprises a grating with a checkerboard like phase structure that diffracts light in two dimensions.

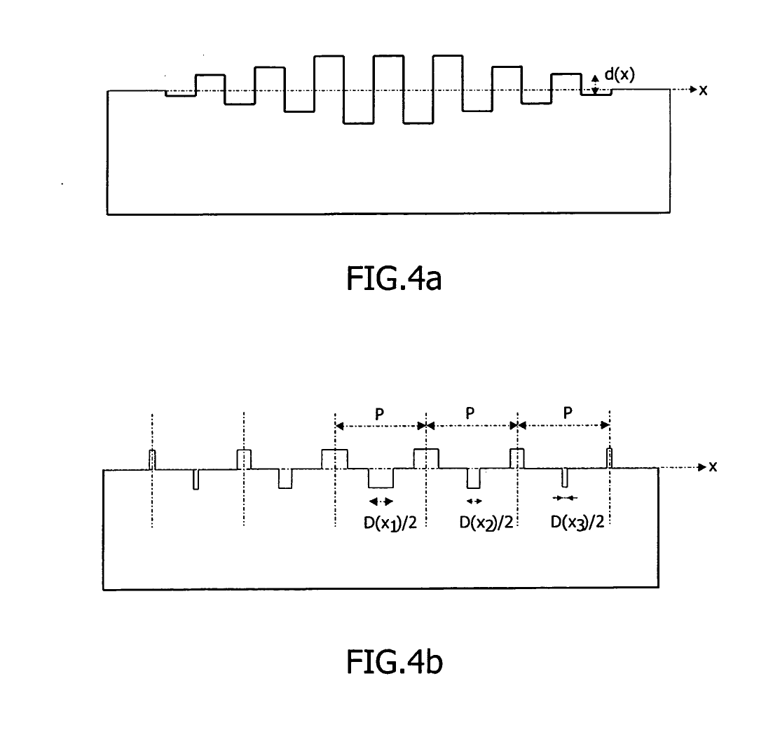

FIG. 4a is a cross section of an optical component in an advantageous embodiment of the invention. Such an optical component has a phase structure with a phase depth δ(x) which decreases from the central axis to the outer envelope of the radiation beam when the optical component is placed in the optical path. If d(x) is the mechanical depth of the phase structure, the phase depth δ(x) is defined by the expression:
δ(x)=(n−1)d(x)π/λ,
where n is the index of refraction of the optical component and λ the wavelength of the radiation beam 102. Moreover, the transmission T(x) of the optical component is defined by the expression:
T(x)=cos²δ(x).

As a consequence, the optical component has a transmission T(x) which increases from the central axis to the outer envelope of the radiation beam when the optical component is placed in the optical path. If the phase depth δ(x) varies in the same way as the intensity distribution of the radiation beam, the rim intensity may be close to one.

In the example, of FIG. 4a, the phase structure is symmetrical around the axis denoted “x”. In this case, this optical component does not introduce any wavefront aberration in the radiation beam.

FIG. 4b is a cross section of an optical component in a preferred embodiment of the invention. Such an optical component has a phase structure with a duty cycle which decreases from the central axis to the outer envelope of the radiation beam when the optical component is placed in the optical path. The duty cycle is defined as D(x)/P, where P is the period of the phase structure and D(x) is the quantity represented in FIG. 4b. The transmission of the optical component of FIG. 4b is given by the expression:
T(x)=1−D(x)(1−cos²δ)/P,
where δ is the phase depth as defined hereinbefore, δ being constant in the optical component in accordance with this preferred embodiment. As the duty cycle decreases from the central axis to the outer envelope of the radiation beam, the transmission of the optical component increases. The optical component of FIG. 4b is particularly advantageous, because it does not introduce wavefront aberrations in the diffracted and un-diffracted beams. Actually, the phase depth δ of the phase structure is constant. The phase structure of the optical component of FIG. 4b is periodic, which means that this optical component can also be used for creating the two satellite spots used for the 3 spots push-pull tracking method.

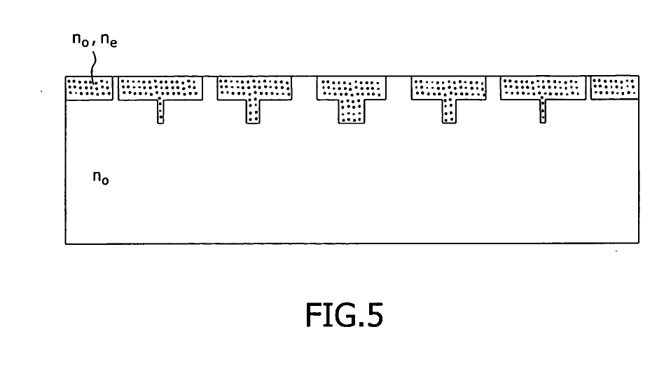

FIG. 5 shows an optical component with a switchable diffraction profile. The optical component of FIG. 5 is similar to the one of FIG. 4b, but the phase structure comprises a liquid crystal material with liquid crystal molecules. In this example, the refractive index of the optical component is chosen equal to the ordinary refractive index nₒ of the liquid crystal material. The liquid crystral molecules can be rotated in that a suitable potential difference is applied between electrodes, not shown in FIG. 5. When the liquid crystal molecules are oriented perpendicular to the polarization of the radiation beam 102 of FIG. 1, the effective refractive index of the liquid crystal molecules is nₒ. As a consequence, the optical component is a neutral element, which means that the radiation beam is not diffracted by said optical element. When the liquid crystal molecules are oriented parallel to the polarization of the radiation beam 102 of FIG. 1, the effective refractive index of the liquid crystal molecules is the extraordinary refractive index of the liquid crystal material, nₑ. As a consequence, the optical component is a grating as described in FIG. 4b.

As a consequence, the optical component of FIG. 5 can be switched between a first mode in which it has a first diffraction profile and a second mode in which it has a second diffraction profile. Depending on to the mode of operation of the optical device, i.e. writing or reading, the mode of the optical component is selected by means of voltages applied to electrodes of said optical component. During writing, the liquid crystal molecules are oriented perpendicular to the polarization of the radiation beam 102. Hence, the radiation beam is not diffracted, and the rim intensity remains relatively low. During reading, the liquid crystal molecules are oriented parallel to the polarization of the radiation beam 102. Hence, the radiation beam is diffracted as described in FIG. 4b, and the rim intensity is increased.

It should be noticed that the optical component of FIG. 5 is only one example of optical component having a switchable diffraction profile. For example, an optical component based on the optical component of FIG. 4a with liquid crystal molecules is also possible.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical device comprising a radiation source for producing a radiation beam and means for focusing the radiation beam on an information carrier along an optical path, said radiation beam having a central axis and an outer envelope, said radiation beam having an intensity distribution, the optical device further comprising, in the optical path, an optical component designed for increasing the ratio between the intensity near the envelope and the intensity near the central axis in that at least the radiation beam near the central axis is diffracted.

2. An optical device as claimed in claim 1, wherein the radiation beam comprises at least a first and a second direction perpendicular to the central axis, the radiation beam having a first intensity distribution with a first mean intensity in the first direction and a second intensity distribution with a second mean intensity in the second direction, said second mean intensity being greater than the first mean intensity, wherein the optical component is designed for diffracting the radiation beam in the second direction more strongly than in the first direction.

3. An optical device as claimed in claim 1, wherein the optical component has a phase structure with a phase depth which decreases from the central axis to the outer envelope of the radiation beam.

4. An optical as claimed in claim 1, wherein the optical component has a phase structure with a duty cycle which decreases from the central axis to the outer envelope of the radiation beam.

5. An optical device as claimed in claim 1, wherein the optical component has a phase structure with a diffraction profile which can be changed in accordance with a mode of operation of the optical device.

6. An optical device as claimed in claim 1, wherein the optical component has a periodic phase structure.

7. A method of writing to and reading from an information carrier with an optical device comprising a radiation source for producing a radiation beam and means for focusing the radiation beam on the information carrier along an optical path, said radiation beam having a central axis and an outer envelope, said radiation beam having an intensity distribution, said method comprising the steps of:
providing in the optical path, during writing, an optical component designed for increasing the ratio between the intensity near the envelope and the intensity near the central axis in that a first percentage of the beam near the central axis is diffracted;
changing the diffraction profile of said optical component during reading, such that said optical component diffracts a second percentage of the intensity of the beam near the central axis, the second percentage being larger than the first percentage.

8. An optical component comprising a phase structure having a variable phase depth.

9. An optical component comprising a phase structure having a variable duty cycle.

10. An optical component as claimed in claim 8, wherein the phase structure is periodic.

11. An optical component as claimed in claim 9, wherein the phase structure is periodic.
